(19) United States
(12) Patent Application Publication
(10) Pub. No.: US 2006/0102011 A1
(43) Pub. Date: May 18, 2006

(54) Coffee filter

(76) Inventor: Shiu Po Fung, New Territories (CN)

Correspondence Address: ALIX YALE & RISTAS LLP, 750 MAIN STREET, SUITE 1400, HARTFORD, CT, 06103, US

(21) Appl. No.: 11/274,978

(22) Filed: Nov. 16, 2005

(30) Foreign Application Priority Data
Nov. 16, 2004 (CN) 200420057524.6

(51) Int. Cl. A47J 31/00

(52) U.S. Cl. 99/279

(57) ABSTRACT

A coffee filter includes a filter bowl, a handle and a control valve, wherein the valve needle of the control valve is fitted below the valve opening of the filter bowl. The valve needle is sleeved with a return spring that exerts an upward force to the valve needle, so that its top butts against the valve opening. A pivotal drive rod is hinged onto the handle to exert a downward force to the valve needle, so that its top is disposed from the valve opening.

### BACKGROUND OF THE INVENTION

The present invention generally relates to a coffee filter.

Coffee filters fitted to the steam outlet of a coffee roaster are used to make delicious, foamy espresso by virtue of steam pressure. The coffee filter primarily includes a valve needle that is sleeved with a return spring, which moves up and down along the valve opening according to the change of coffee juice pressure, and by this way a gap is formed for the outflow of coffee. Good coffee cannot be made if the gap is too large. On the other hand, the coffee espresso often contains fine particles. A small gap will result in blockage between the valve needle and the valve opening, which will result in dangerous excessive pressure. Therefore, cleaning work is often needed and is really bothersome.

In present technology, the valve needle is often fitted with a cover board of large area. It is placed above the valve opening; therefore, the valve needle can be moved with less pressure. However, with this structure cleaning is very difficult, and the coffee flows too slowly to carry away the steaming at normal working pressure. Once the pressure is too large, the cover board of the valve needle will seal the valve opening. As a result, the filter has to be disassembled from the coffee roaster, which is then cleaned thoroughly after the valve needle has been taken out. The latter is truly a bothersome operation. Furthermore, if there is still residual liquid or gas inside the valve, and the pressure is not high enough to open the valve needle by the time the filter is removed from the coffee machine, then there is a potential burn hazard.

### SUMMARY OF THE INVENTION

To solve the above problems, the present invention provides a coffee filter which not only makes high quality coffee, but also is easy and convenient to clean with a high degree of safety.

Briefly stated, the coffee filter in a preferred form includes a filter bowl, a handle and a valve needle. The valve needle is fitted below the valve opening of the filter bowl. The valve needle is sleeved with a return spring that exerts an upward force to the valve needle, so that its top engages against the valve opening. A turnable drive rod that is hinged onto the handle exerts downward force to the valve needle, so that its top disengages from the valve opening.

The application end of the drive rod is provided with a seizing notch that can seize the valve needle. The notch opening has an angular structure.

The valve needle has a flange, and its position is in the travel path of the seizing notch of the drive rod.

The present invention is efficient to use. If the pressure inside the filter bowl is sufficient, the top end of the valve needle is forced to move down to form a gap between the valve needle and the valve opening. Coffee foam is produced when coffee juice goes through the valve opening and suddenly releases. After coffee is served out, when holding the handle and taking off the filter, the drive rod is grasped naturally together with the handle. As a result, the seizing notch of the drive rod seizes the valve needle and forces it to move downward and disengage from the valve opening, which discharges accumulated residual vapor. This ensures the user safety. When the drive rod and the handle are held tightly, the largest gap is reached between the valve needle and the valve opening. At this point the filter is flushed. The dregs can be completely removed. The handling is convenient and easy with a greatly increased working efficiency.

### BRIEF DESCRIPTION OF THE DRAWINGS

FIG. 1 is a disassembled exploded view of structural components of a coffee filter in accordance with the present invention.

FIG. 2 is an assembly view of the coffee filter of FIG. 1.

FIG. 3 is a sectional view along the A-A of FIG. 2.

FIG. 4 is a sectional view along the line B-B of FIG. 3.

### DETAILED DESCRIPTION OF THE PREFERRED EMBODIMENTS

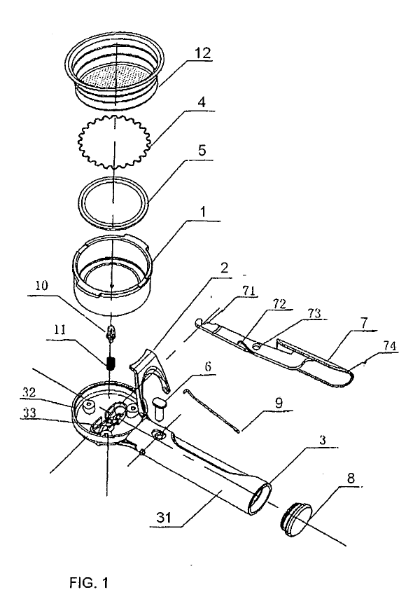

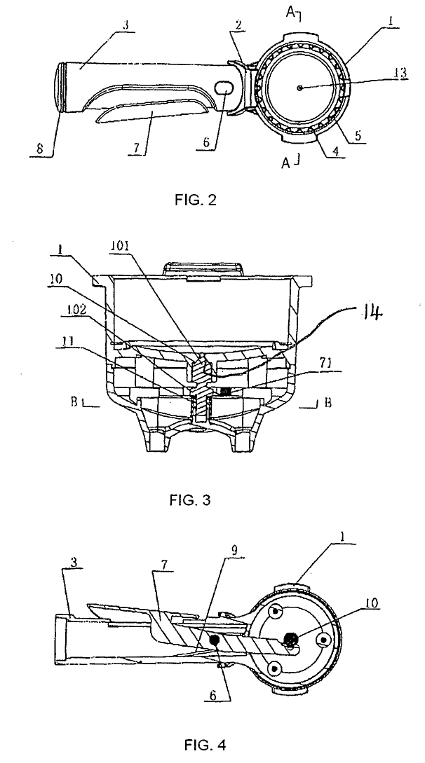

As shown in FIG. 1 and FIG. 2, one embodiment of a coffee filter in accordance with the present invention includes generally, among other components, a coffee filter basket 12, a filter bowl 1, a bowl clamp 2, a handle 3, a spring washer 4, a seal ring 5, a fixed axle 6, a drive rod 7, a return spring 11, a control valve needle 10, and a pressure spring 9.

Spring washer 4 and seal ring 5 are placed in the circular groove in the base of filter bowl 1. Filter bowl 1 has a compass bottom with valve opening 13 in the middle. On the lower surface of the filter bowl disposed below valve opening 13, is an upper valve seat 14 of a hollow column shape for fixing valve needle 10. The upper valve seat 14 has larger inner diameter than the valve opening 13. In their sealing interface, namely, the in the lower aperture of valve opening 13, there is a transitional hollow cone.

Handle 3 comprises a handle lever 31 and a tray 32 that is fixed onto the bottom of the filter bowl 1. Handle lever 31 is hollow tubular shaped, and its end is sealed with an end cap 8. Bowl tray 32 of handle 3 is fixed with filter bowl 1 by virtue of a filter bowl clamp 2. The tray is provided with lower valve seat 33 in the middle corresponding to the position of valve opening 13.

As shown in FIG. 3, a valve needle 10 is installed below valve opening 13 between the lower valve seat 33 and the upper valve seat 14. A cone-shaped top of valve needle 10 matches the shape of the lower aperture of valve opening 13, and they fit tightly to seal valve opening 13. Its circumference is “cross” diamond shaped (4 vertical groove 101). Valve needle 10 has a flange 102 in the middle, and a ring groove is formed between the flange 102 and the upper body of the valve needle. The valve needle body below flange 102 is sleeved with a return spring 11. One end of the return spring 11 butts against valve needle flange 102, and the other end butts against the center of the bottom of tray 32 of handle 3. By this way, the return spring 11 exerts an upward force against the valve needle 10, which makes its top butt against the lower aperture of valve opening 13.

As shown in FIG. 4, drive rod 7 is fitted inside handle 3 by a fixed axle 6, and it can rotate around the axle 6. A mounting hole 73 in the middle of the drive rod 7 accommodates fixed axle 6. Drive rod 7 pivots about mounting hole 73. One side is the application end, and the other side is the hand drive end. The application end is provided with seizing notch 71 that seizes the valve needle. The notch opening has an angular structure. The hand drive end is provided with curved press grip 74 that matches the shape of handle 3, which is convenient to use. The flange 102 of the valve needle 10 is located in the travel path of the seizing notch 71 of the drive rod (refer to FIG. 3 and FIG. 4). Due to the angular structure of the notch opening, when the notch 71 moves toward the valve needle and contacts with flange 102, the flange 102 moves downwards along the slope. As a result, the whole valve needle 10 is driven to overcome the applied force of return spring 11 and moves downwards, so that its top leaves the valve opening 13. In addition, there is a slot 72 in the drive rod 7 for fixing the pressure spring 9. The other end of the pressure spring 72 butts against the inner wall of handle 3, so that a fixed included angle between drive rod 7 and handle 3 is formed.

In use, the proper amount of coffee is added in coffee filter basket 12, which then is placed onto filter bowl 1, and then the coffee filter is wholly mounted in the coffee machine. Now valve needle 10 is in the state of blocking valve opening 13 under the force of the return spring 11. In the beginning of coffee making, coffee juice accumulates continuously in the filter bowl 1. When the steam pressure is high enough, the valve needle is pressed down, and a gap between the cone top of valve needle 10 and valve opening 13 is formed. Under the steam pressure, the coffee juice goes through the small gap of 0.2±0.03 mm between the valve opening and the valve needle. It then releases suddenly when flowing through the bigger gap path formed between vertical groove 101 of valve needle 10 and the hollow column of upper valve seat 14, thereby producing a significant amount of coffee foam. After the coffee is served out, to take out the filter, the handle 3 is held, and drive rod 7 is naturally grasped together with the handle 3. Now seizing notch 71 of the drive rod 7 seizes the valve needle 10 and makes it move down and separate from the valve opening 13, which discharges dregs and residual vapor in filter bowl 1. This ensures the users' safety.

For cleaning, the drive rod 7 and the handle 3 are also held tightly together, so that the largest gap is reached between valve needle 10 and valve opening 13. Now it very convenient and easy to flush the filter and completely move dregs with greatly increased handling efficiency.

What is claimed:

1. A coffee filter comprising:
a filter bowl having a valve opening;
a control valve disposed below the valve opening and having a valve needle with a top and a return spring biasing said valve needle so that said top is urged toward said valve opening; and
a handle extending from said filter bowl and a drive rod pivoted to the handle and pivotal to exert a force on the valve needle wherein the top is displaced from the valve opening.

2. The coffee filter of claim 1 wherein the drive rod has an application which has a seizing notch for seizing the valve needle.

3. The coffee filter of claim 2 wherein the notch is defined by an angular structure.

4. The coffee filter of claim 2 wherein the valve needle has a flange and said flange is disposed in the travel path of the seizing notch.

5. The coffee filter of claim 4 wherein the filter bowl has a lower surface defining an upper valve seat disposed below the lower aperture of the valve opening and the handle has a tray having a lower valve seat positioned to align with the valve opening wherein the valve needle is installed between the upper valve and the lower valve seat for axial movement.

6. The coffee filter of claim 1 wherein the drive rod is fitted inside the handle by a fixed axle for rotation about the axle.

7. The coffee filter of claim 6 further comprising a pressure spring disposed between the handle and the drive rod to form an included angle between the drive rod and the handle.

8. The coffee filter of claim 5 wherein the top of the valve needle is cone shaped and is complementary with the lower aperture of the valve opening.

9. The coffee filter of claim 8 further comprising a vertical groove on the circumference of the valve needle.

10. The coffee filter of claim 6 wherein the drive rod has a hand drive end and a curved press grip matches the shape of the handle.

11. The coffee filter of claim 8 wherein a gap is disposed between the valve needle and the lower aperture of the valve opening and said gap is 0.2±0.03 mm.
